(19) United States
(12) Patent Application Publication
(10) Pub. No.: US 2003/0121586 A1
(43) Pub. Date: Jul. 3, 2003

(54) Tack-on-pressure films for temporary surface protection and surface modification

(75) Inventors: Sumita B. Mitra, West St. Paul, MN (US); Sundaravel Damodaran, Maplewood, MN (US); Hak-Rhim Han, Newport, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 10/016,541

(22) Filed: Dec. 11, 2001

(51) Int. Cl. A44B 19/00; A41H 37/00; B32B 7/12; B32B 15/04

(52) U.S. Cl. 156/66; 428/343; 428/354

(57) ABSTRACT

A method for temporary surface protection or surface modification using a sheet material is disclosed. In the inventive method, a selectively activated adhesive is provided on one side of a three-dimensional sheet material for maintaining the sheet material in place for uses such as the dental bib, tool tray liner, or providing desired optical effects on a surface to which the sheet material has been adhered.

### CROSS-REFERENCE TO RELATED APPLICATION(S)

This invention is related to a U.S. patent application entitled “Film Structures and Methods of Making Film Structures” (Ser. No. ______; 3M Attorney Docket No. 55947US002), co-assigned to 3M Innovative Properties Company and concurrently filed with the present application.

### BACKGROUND OF THE INVENTION

This invention relates to sheet materials, such as polymeric sheet webs or composite laminates, used for temporary surface protection or surface modification. More particularly, this invention relates to sheet materials having an activatable adhering side such as an adhesive side with tack-on-pressure property, and a utility side with a multiplicity of features including various surface properties such as asepsis, impermeability to fluids, absorbency of fluids, high coefficient of friction, and optical characteristics.

Sheet materials are widely used for various purposes through surface contact with another object to provide surface protection or surface modification. Typically, a useful sheet material for such purposes has an adhering side and an opposing utility side. As the adhering side of the sheet material is adhered to a surface of a target object, it covers the surface of the target object, leaving the utility side of the sheet material exposed. Depending on the characteristics of the utility side of the sheet material, protection or modification of the surface of the target object is obtained.

In the above-described applications, often a user wishes to have control over when, where, and how the sheet material is applied. The user often also wants the sheet material to be easily removable when the desired surface protection or modification is no longer required.

For example, in the art of tapes, labels, and other articles using pressure-sensitive adhesive (PSA) to adhere an adhesive coated surface to a target surface, premature adhesion sometimes is a problem. That is, before the adhesive coated surface can be properly positioned over the target surface, inadvertent contact of the adhesive with the target surface causes premature adhesion at one or more locations, thereby inhibiting proper positioning. Additionally, inadvertent contact between different parts of the same adhesive coated surface can also create problems and waste. Pressure-sensitive adhesive sheet structures (composed of a substrate such as a film or sheet and a pressure sensitive adhesive layer formed on its surface), for example, are employed in a wide range of applications such as signboards, decorative and display applications in automobiles, buildings and containers. Such pressure-sensitive adhesive layers have very high initial adhesion strength, making the adhesion highly uncontrollable. Where the precise positioning of the film structure is required, even skilled workmen experience difficulty in accurately bonding such a pressure sensitive adhesive layer to the desired site in one operation, and removal from the desired site is often necessary. But with a traditional pressure-sensitive adhesive, once the initial contact is made, it is difficult to adjust the position of the film structure.

Another example where more user control is wanted is plastic thin films widely used to wrap food. Most commercial food wraps undesirably “cling” to themselves when they are dispensed. Such undesirable properties makes the application of the film difficult to control.

In the medical field, due to hygienic or aseptic requirements, it is desirable to have a sheet material to cover various surfaces of items found in a hospital or a dental office. In this case, it is further desirable that the sheet material be disposable, repositionable, easy to adhere to a target surface, and easily removable. It is also desirable that the sheet material have low costs of production Due to either lack of proper materials or lack of realization how the existing materials may be utilized in this particular field, a solution satisfactory with the above concerns has not been developed.

Low tack or nesting-resistant sheet materials are known. U.S. Pat. No. 5,866,220 to Rusincovitch et al., for example, discloses a, method of making repositionable wall covering by transferring printed spacers or projections to a adhesive layer such that areas of the adhesive layer are covered or spaced from the wall by spacers or projections, resulting a low tack film. U.S. Pat. No. 5,965,235 to McGuire et al., for example, discloses a three-dimensional sheet material having an application side from which a plurality of spaced three-dimensional protrusions extend outwardly. The protrusions are separated by an interconnected network of three-dimensional spaces between adjacent protrusions. The sheet structure disclosed in McGuire et al. is designed to resist nesting of superimposed layers into one another. The three-dimensional, nesting-resistant sheet materials are manufactured utilizing a three-dimensional forming structure comprising an amorphous pattern of spaced three-dimensional recesses separated by interconnected lands. To manufacture the three-dimensional, nest-resistant sheet materials, a sheet of the formable material is introduced onto the forming structure and permanently deformed into compliance with the forming structure.

Furthermore, a U.S. patent application entitled “Film Structures and Methods of Making Film Structures” (Ser. No. ______; 3M Attorney Docket No. 55947US002), co-assigned to 3M Innovative Properties Company (3M) and concurrently filed with the present application, discloses several novel methods to make sheet materials that are activated by the application of pressure (tack-on-pressure). The resultant film structure has a controllable adherence because the degree of contact between the adhering side and the surface of a target object to which the sheet material is applied is controllable by applying a pressure on the film structure. The film does not stick to the target surface quickly until the adhesion is activated by applying a pressure in a direction transverse to the target surface on the backside of the sheet (“tack-on-pressure”). The sheet material can be made repositionable or removable after the adhesion has been activated.

### BRIEF SUMMARY OF THE INVENTION

The present invention discloses a novel method to provide temporary surface protection or surface modifications. In general, a sheet material having an activatable adhering side such as an adhesive side with tack-on-pressure property, and a utility side with multiplicity of features including various surface properties such as asepsis, impermeability to fluids, absorbency to fluids, high coefficient of friction, and optical characteristics is used to provide a desired surface protection or surface modification.

In one aspect of the invention, a method for temporary surface protection or surface modification comprises: 1) providing a sheet material having an activatable adhering side and an opposing utility side; 2) applying the activatable adhering side of the sheet material on a target surface; and 3) activating the activatable adhering side; wherein the sheet material has a base portion having physical characteristics of having been non-elastically stretched in at least one dimension by a stretch ratio of at least 1:1.05; the activatable adhering side comprises a plurality of predetermined surface elements separated from each other leaving openings between adjacent surface elements, the separation or the increase in separation being caused by stretching of the sheet material; and the sheet material further has an adhesive layer at least partially exposed to the activatable adhering side through the openings between surface elements such that after activation by a user, the activatable adhering side exhibits an adhesion peel force greater than an adhesion peel force exhibited prior to activation by a user.

In another aspect of connection, a method for temporary surface protection or surface modification in a hospital or dental office comprises: 1) providing a multilayer sheet material having an activatable adhering side and an opposing utility side, wherein after activation by a user, the activatable adhering side exhibits an adhesion peel force greater than an adhesion peel force exhibited prior to activation by a user, such that the sheet material is easily repositionable before being activated and still removable by peeling after being activated; 2) applying the activatable adhering side of the sheet material on a target surface commonly found in a hospital or a dental office, wherein the utility side of the sheet material provides a desired surface contact property not available on the target surface; 3) activating the activatable adhering side; and 4) removing the sheet material from the target surface after the desired surface contact property is no longer required.

In other aspects of the invention, a bib wearable by a user, a medical tray liner adapted to fit on a surface of a medical tray, and a sheet material used as a light control filter when applied over a light source are disclosed. The bib, the tray liner, and the light filter are particularly suitable in dental applications.

### BRIEF DESCRIPTION OF THE DRAWINGS

The present invention will be further explained with reference to the drawing figures listed below, wherein like structures are referred to by like numerals throughout the several views.

FIG. 1A is a perspective view of a tack-on-pressure sheet material being applied and activated on a target surface in accordance with the present invention.

FIG. 1B is a side sectional view of an exemplary tack on pressure sheet material used in accordance with the present invention.

FIG. 2A is a perspective view of a bib in accordance with the present invention.

FIG. 2B shows a bib of the present invention being worn by a patient in a dental office.

FIG. 2C shows a bib of the present invention being alternatively used as a barrier film over a medical or dental tool tray.

FIG. 3 is a perspective view of a medical tray liner in accordance with the present invention.

FIG. 4A shows a sheet material used for wrapping around a handle of the medical or dental tool in accordance with the present invention.

FIG. 4B shows a medical or dental tool with a sheet material wrapped around a handle thereof.

FIG. 5 is a perspective view of the light control filter in accordance with the present invention.

FIG. 6 is a side sectional view of a film structure before the film structure is stretched according to a first method for making the sheet material of the present invention.

FIG. 7A is a side sectional view of a film structure after the film structure is stretched according to the first method for making the sheet material of the present invention.

FIG. 7B is a schematic top view of a film structure after the film structure is stretched according to the first method for making the sheet material of the present invention.

FIG. 7C is a side sectional view of a film structure after the film structure is stretched according to a variation of the first method for making the sheet material of the present invention (wherein particles are incorporated within the operating agent).

FIG. 8 is a side sectional view of a film structure before the film structure is stretched according to a second method for making the sheet material of the present invention.

FIG. 9A is a side sectional view of a film structure after the film structure is stretched according to the second method for making the sheet material of the present invention.

FIG. 9B is a schematic top view of a film structure after the film structure is stretched according to the second method for making the sheet material of the present invention.

FIG. 10 is a side sectional view of a film structure according to a third method for making the sheet material of the present invention, and before the film structure is stretched.

FIG. 11A is a side sectional view of a film structure after the film structure is stretched according to the third method for making the sheet material of the present invention.

FIG. 11B is a schematic top view of a film structure after the film structure is stretched according to the third method for making the sheet material of the present invention.

While the above-identified drawing figures set forth several embodiments of the invention, other embodiments are also contemplated, as noted in the discussion. In all cases, this disclosure presents the present invention by way of representation and not limitation. It should be understood that numerous other modifications and embodiments can be devised by those skilled in the art which fall within the scope and spirit of the principles of this invention.

### DETAILED DESCRIPTION

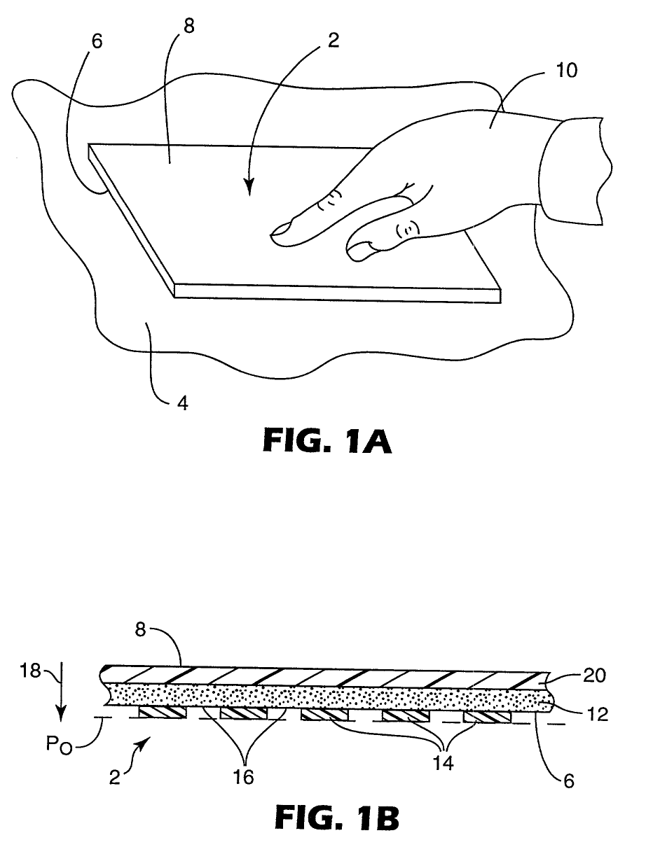

In FIG. 1A, a tack-on-pressure sheet material 2 is being used in accordance with the present invention to protect a surface 4 of a target object (not shown) or to modify a surface property of the target surface 4. The tack-on-pressure sheet material 2 has an activatable adhering side 6 and a utility side 8. The activatable adhering side 6 provides the property of controllable or activatable adhesion.

FIG. 1B shows an exemplary sheet material 2 having activatable adhesion. The sheet material 2 has on the adhering side 6 an adhesive layer 12 and a plurality of spacers or protrusions 14 partially covering the adhesive layer 12. The spacers 14 space adhesive 16 of the adhesive layer 12 from plane Pₒ of the sheet material 2.

With reference to both FIG. 1A and FIG. 1B, as the sheet material 2 is initially placed on the target surface 4, only the end surfaces (not shown) of the spacers 14 contact the target surface 4 because the adhesive layer 12 is spaced from the target surface 4. In a sense, the adhesion of the adhering side 6 is not “activated” at this initial stage of contact. The adhesion can be subsequently controllably activated because the degree of contact between the adhesive 16 on the adhering side 6 and the target surface 4 is controllable by applying a pressure transverse to the target surface 4 on the utility side 8. As a user 10 applies a finger or hand pressure in the direction represented by arrow 18, adhesive 16 starts to contact the target surface 4 by virtue of either deformation of the base portion 20 of the sheet material 2 or deformation of the spacers 14 (or deformation of both the base portions 20 and the spacers 14). As the adhesive 16 starts to contact the target surface 4, the adhesion of the sheet material 2 is activated. The sheet material 2 does not stick to the target surface 4 quickly or readily until the adhesion is activated.

Depending on the desired application, the activatable adhesion property may be present on the entire adhering side 6 or only on a portion thereof. Furthermore, if desired, only a selected area or areas of the adhering side 6 having activatable adhesion property may be activated. The target surface 4 can be of any shape and have any surface feature, as long as it does not undesirably interfere with the activation of the adhesion property of the sheet material 2. When the target surface 4 is smooth, a larger activation force will be required than when the target surface is rough. For instance, when the sheet material is applied over apparel (rough target surface), the tufted fibers from the apparel can make contact the adhesive even with a small extent of deformation of the sheet material.

For the types of applications envisioned by the present invention, the activation of the adhesion property is accomplished by applying a finger or hand pressure or its equivalent on the utility side. In this disclosure, a finger pressure or a hand pressure refers to the kind of pressure an average user would normally apply using his/her finger or hand when trying to adhere a pressure sensitive adhesive coated film to a surface. However, any pressure that successfully activates the activatable surface contact property is suitable. The utility side 8 of the sheet material 2 can have various desired surface properties not found on the target surface 4. The desired surface properties include but are not limited to asepsis, cleanness, high durability, hazard resistance, impermeability to fluids, absorbency to fluids, a desired (e.g., high) coefficient of friction, and various optical characteristics such as color, transparency or translucency. The sheet material 2 can be made repositionable or removable after the adhesion has been activated such that it may be removed from the target surface 4 when the desired surface property is no longer required. The sheet material 2 thus provides temporary surface protection or surface modification without using any accessories such as fasteners and without damaging the target surface 4.

A desired surface property is not required to be present on the entire utility side 8. For instance, it may be present in a selected area or areas only. The utility side 8 may also have a combination of more than one desired surface property, either in the same areas or alternate areas respectively. Furthermore, when adhesion is activated only in selected areas of the adhering side 6, these activated areas may or may not be coordinated with the areas on the opposing utility side 8 that provide the desired surface property. For example, the adhering side 6 may be activated in peripheral areas only while the desired surface property is present on central areas of the utility side 8.

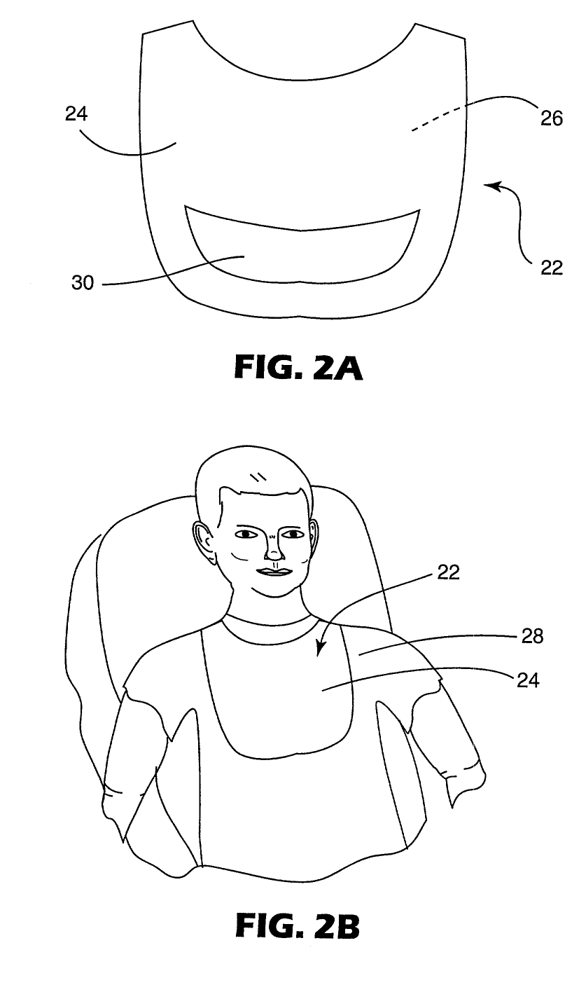

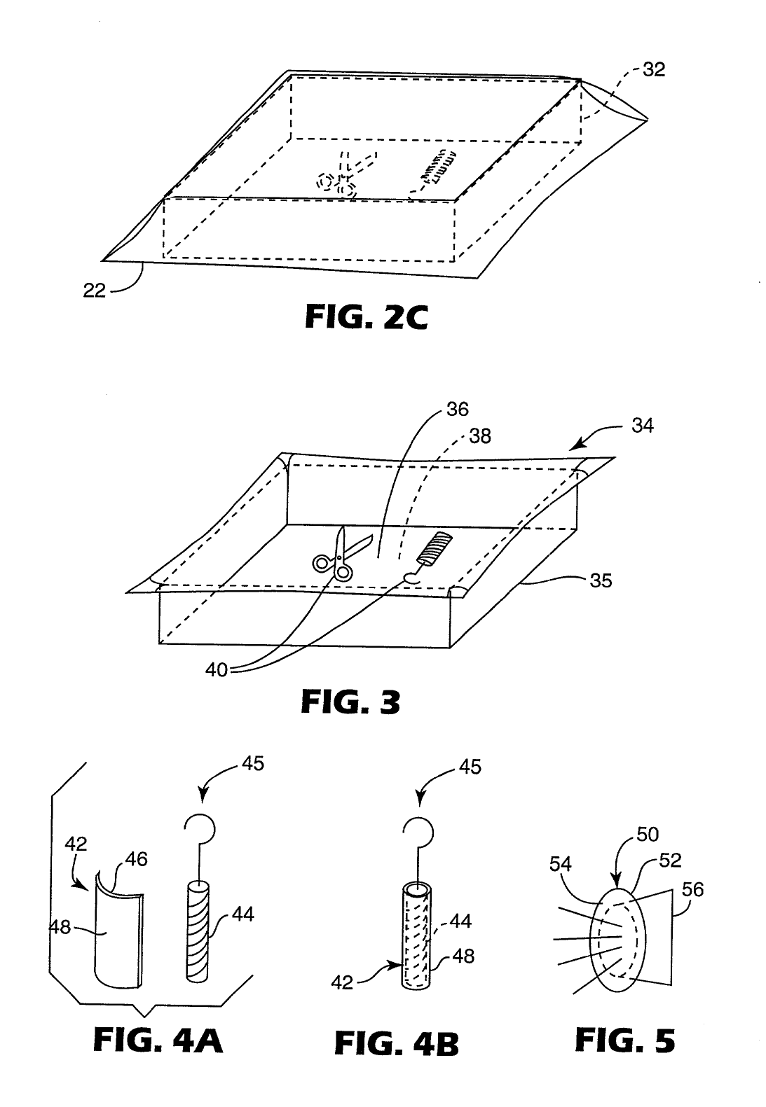

FIGS. 2A and 2B show a bib 22 worn by a user such as a child or a dental patient in accordance with the present invention. The bib 22 has a utility side 24 and an activatable adhering side 26. Preferably, the bib 22 has a multilayer structure with an outer layer for the utility side 24 being a polymeric material impermeable to liquids. Unlike traditional bibs, the bib 22 does not have to utilize any accessories such as fasteners, ties or belts. A user simply places the bib 22 at a proper position on the user's body 28 (most likely in the thoracic region) and then activates the tack-on-pressure adhering side 26 by using a finger pressure or a hand pressure. When the sheet material is applied over apparel (a rough target surface), the tufted fibers from the apparel can contact the adhesive even with a small amount of pressure. It is possible that the mere action of laying down the bib over a reclining dental patient, can result in adequate adhesion of the bib to the apparel of the patient, thereby minimizing the need for additional finger pressure. The bib 22 can be easily removed after use.

In one embodiment, the bib 22 is a dental bib worn by a dental patient. In the present application, the word “dental” includes all dental specialties such as orthodontics, periodontics, prosthodontics, dental prosthetics, dental hygienics, dental implantology, and orofacial pain treatment. Traditionally, dental bibs are kept in place by several fasting devices such as alligator clips attached to a small linked metal chain that extends around the dental patient's neck. Such dental bibs are cumbersome and frequently require considerable manipulation by a dental practitioner or staff. In contrast, the inventive bib 22 with tack-on-pressure feature can be placed on the dental patient without the use of any other fastening devices. In this case, the bib 22 is preferably made of light and soft materials, having been hygienically treated and rendered disposable. In one embodiment, at least part of the utility side 24 of the bib 22 is absorbent to liquids so that saliva and other oral environment liquids generated by the patient or during the dental procedure can be captured, and so that a practitioner working on the dental patient may wipe dental tools on the bib 22. For example, a liquid absorbent material 30 may be attached to the utility side 24 of the bib 22 for the above purpose (on the entire side 24 thereof, or just on one or more desired sections of the side). While the comments above relate to dental bibs, the present invention is equally applicable to other suitable medical applications (e.g. a medical drape which may or may not be actually adhered to the patient), as well as consumer applications (e.g., feeding bibs for use by infants, or in nursing homes, hospitals and restaurants).

FIG. 2C shows the dental bib 22 of the present invention being alternatively used as a protective barrier film over the dental patient's tray set up 32, which is often prepared hours ahead of the dental procedure. Due to the light and flexible material used, the bib 22 can simply be placed over (and adhered to) the tray set up 32. The protective barrier film (bib 22) provides extra infection control before the dental procedure and can be easily removed and placed on the user 28 (i.e., the dental patient) as bib 22 (FIG. 2B) during the dental procedure. Additionally, for purpose of visibility of the content of the tray set up 32, the protective barrier film (bib 22) may be made (in part or in whole) of a material transparent to visible light. While FIG. 2C has been described in the context of a protective cover film for a dental tray, it will be readily appreciated that barrier films of similar construction may be used to protect medical instrument trays in general.

For example, FIG. 3 shows a medical tray liner 34 used with a medical tray 35. The liner 34 has a utility side 36 and an activatable adhering side 38. After the adhering side 38 has been activated, medical tools 40 (or other utilities and accessories) can be placed on the utility side 36. The tray liner 34 can be treated to meet hygienic or aseptic requirements. The tray liner 34 may be further made disposable, making it much easier to meet hygienic or aseptic requirements as compared to treating the medical tray 35 prior to every use.

Furthermore, the utility side 36 of the medical tray liner 34 may be a microstructured surface that has a desired friction coefficient, such as a high friction coefficient to prevent the medical tools 40 placed thereon from sliding freely. One method of providing such a microstructured surface is disclosed in PCT Patent Application WO 00/20210 entitled “Friction Control Article for Wet and Dry Applications”, assigned to 3M Innovative Properties Company.

Furthermore, the tray liner 34 may be subsequently used as a medical or dental bib 22 as described herein. The tray liner 34 may also be used in combination with a protective barrier film, which itself may be used as a bib 22, as described herein.

FIG. 4A shows a sheet material 42 used for wrapping around a handle 44 of a medical or dental tool 45. The sheet material 42 has an activatable adhering side 46 and a utility side 48. When wrapped around handle 44 (FIG. 4B), the sheet material 42 provides hygienic or aseptic access to tool 45 for a medical or dental practitioner or a fabricator of a medical or dental prosthetic device. Preferably the sheet material 42 is made of a flexible material to easily conform to the outer surface of the handle 44. Sheet material 42 may be further made disposable. Using non-aggressive adhesion, the sheet material 42 can be easily removed without leaving a residue on the tool 45.

The use as shown in FIGS. 4A and 4B can be for infection protection over surfaces frequently touched by a medical or dental practitioner. Such surfaces may include, without limitation, operating light handles, chair buttons, handpieces, curing lights, etc.

FIG. 5 shows a sheet material 50 having an activatable adhering side 52 and a utility side 54 used as a light-control filter placed over a light source 56. A colored sheet material 50 can be used to temporarily alter the optical characteristics of the light source 56, a gradient gray sheet material 50 can be used to temporarily reduce the light density from the light source 56, while a colorless transparent sheet material 50 can be used to temporarily protect a front of the light source 56. As described herein, the tack-on-pressure feature of sheet material 50 facilitates convenient temporary alteration without any permanent change on the light source 56 and without leaving any adhesive residue thereon once removed. For example, a sheet material 50 designed to block light of a specific wavelength range can be tacked on a front surface of a dental operating light while a restoration is being made to protect a light activated material, such as a visible light activated material (VLC), from premature polymerization. For commonly used VLC materials, such a sheet material 50 should preferably block out light of wavelengths about 400 nm to 500 nm. For example, the sheet material 50 can be a transparent sheet orange in color that filters out the blue light from conventional dental curing lights. However, where a different light activated material and/or a different dental curing light is used, the optical characteristic of the sheet material 50 may be selected accordingly.

Sheet material 50 may be provided in precut disks. In addition to being used over a light source, such precut disks of sheet material 50 may be adapted to protect other surfaces. For example, a sheet material 50 may be used as a disposable temporary protective layer on a dental mirror to guard against pitting from air abrasion. As another example, a clear disc of sheet material 50 can be used as protection for the tip of a light guide on a dental curing light.

Furthermore, lamination of an absorbent layer (not shown) on the exposed (top) surface of the sheet material 50 will allow the user to wipe off fluids such as water, blood, saliva etc.

The adhesive may be a permanent or repositionable pressure sensitive adhesive (RPSA).

In all embodiments described herein, the sheet material can be cut into desired shapes and sizes. Sheet material can be supplied in either roll form or precut discrete pieces. When supplied in a roll form, the nonaggressive tack-on-pressure feature of the sheet material also helps to unwind easily because the sheet material does not cling to itself.

Method of Making

Various methods can be used to make a sheet material having an activatable adhering side. Suitable methods can be found in U.S. Pat. No. 5,866,220 to Rusincovitch et al. and U.S. Pat. No. 5,965,235 to McGuire et al.

Furthermore, a U.S. patent application entitled “Film Structures and Methods of Making Film Structures” (Ser. No. ______; 3M Attorney Docket No. 55947US002), assigned to 3M Innovative Properties Company and concurrently filed with the present application, discloses several novel methods to make tack-on-pressure sheet materials. The above-identified U.S. patent application discloses the method of forming a three-dimensional sheet material having controllable surface contact properties by stretching a film assembly having separable surface elements.

The novel method of the above-identified U.S. patent application is a preferred method for making the sheet material in the present invention because the method is efficient, incurs low costs, and offers a high degree of control over the surface contact properties of the resultant film.

The details of the method of the above U.S. patent application concerns techniques for making a sheet material having controllable surface contact properties. To make such a film, a multilayer film assembly is formed using a suitable method (such as coextrusion or lamination). The multilayer film assembly has an intermediate surface which may include an operating agent, such as an adhesive, preferably in a layer form. The multilayer film assembly may also include a base layer. The multilayer film assembly further has a top portion at least partially masking the intermediate surface (and the operating agent thereof if included). The top portion comprises a plurality of predetermined separable surface elements. For example, the top portion may be a masking layer such as a monolayer of discrete particles, a scored continuous film layer, or a stemmed web.

After formation, the multilayer film assembly is stretched to separate the plurality of predetermined separable surface elements contained in the top portion and at least partially expose and/or increase the degree of exposure of the intermediate surface (and the operating agent thereof if included) through openings or lands between the separated surface elements such that the resultant multilayer film assembly has an activatable surface contact property characterized in: as the first major surface is applied to a smooth surface of the substrate, the intermediate surface and/or operating agent thereof exhibits noticeably greater contact with the surface of the substrate after the multilayer film assembly is activated than before.

Typically, the film assembly is stretched along two mutually perpendicular directions (i.e., biaxial stretching) to separate the surface elements in the plane of the film. However, the film assembly may be stretched along one, or more than two directions, or to unequal extents in each direction depending on the specific performance desired in the final film structure. When stretched in more than one direction, stretching in different directions may be carried out either simultaneously or sequentially. Furthermore, the film assembly may be stretched with interspersed operations. For example, the film may be stretched in one or more directions, then treated with a desirable treatment (such as heating, annealing or simply waiting), and then stretched again either in the same direction or in a different direction. In essence, any manner of stretching may be used as long as it helps to create a desirable separation of the separable surface elements as described herein. Generally, a stretch ratio of at least 1:1.05 is expected. In this disclosure, a stretch ratio of 1:X represents an amount of stretching in a certain direction where the final film length in that direction is “X” times its original length in the same direction.

Attempts in the prior art to produce similar topological features in adhesive films have been based on: 1) coating adhesives into recesses of a textured film; 2) embossing or printing non-adhesive projections over an adhesive film; and 3) randomly breaking up a disruptable thin top layer by deformation (see U.S. Pat. No. 5,948,493 to Groeger).

Among the above listed prior art methods, the coating method has disadvantage of being a two-step process, and further involves rheology control of adhesive. The printing method also has a disadvantage of being a two-step process. The third method results in uncontrolled feature size and surface geometry (i.e., the size and geometry of the broken apart surface elements are random by nature) and limited topological relief by the top portion because the top portion is usually required to be very thin.

In comparison, the inventive method of stretching a film assembly having separable surface elements has several advantages, as discussed below.

The primary function of the stretching process in accordance with the inventive method is to provide a method to obtain a certain controllable surface contact property. The stretching process, however, brings certain additional benefits. For example, the stretching process according to the inventive method can be implemented in-line with conventional film-making equipment, and can therefore be accomplished in an integrated process and offers thin film capability. Since thin webs are usually difficult to manufacture (such as by casting, for example), it is more efficient to first form a thick web, then stretch the thick web and attenuate it to a desired final film thickness. Using the technique in accordance with the present invention, films that are less than 2 mil (0.0508 mm) thick but still have a desired surface contact feature can be made. It is further possible to make films that are less than 0.5 mil (0.0127 mm) thick but still have a desired surface contact feature.

Another additional advantage of incorporating the technique in-line with film lines is lower cost of production. The film forming lines as used according to the present disclosure can be substantially faster than typical web casting and forming operations. Furthermore, film forming lines in this disclosure can produce wider output rolls than most cast processes.

In addition, biaxial film stretching may be carried out using standard film production equipment. Both cast-tentered process and blown-film process are viable means for this purpose. Cast-tentered films may be made sequentially (i.e., stretching in one direction followed by transverse stretching in tenter), or simultaneously (i.e., using a simultaneous tenter). Either mechanical or electromechanical tenters may be employed towards this end.

Various techniques known in the art, such as solvent casting and coextrusion, can be used to form a multilayer construction. If the multilayer construction is made by coextrusion and/or thermal lamination, the individual layers need to be amenable to being processed in a molten state.

Various types of operating agents can be used to make sheet materials suitable for various applications. For the purpose of the present invention, however, the sheet material includes an adhesive layer. To this end, various types of adhesives, including the common repositionable pressure sensitive adhesives (RPSAs), can be used. RPSAs useful in this invention are those that exhibit repositionable, removable characteristics. In this context, the term “repositionable” means that a film sheet covered by the adhesive in a conventional way can be adhered to and removed from a clean solid surface at least two times without substantially losing tack. Preferably, the sheet can be adhered to and removed from a clean solid surface at least ten times, and more preferably, at least twenty times, without substantially losing tack. RPSAs are well known in the art as evidenced by U.S. Pat. Nos. 5,045,569; 4,988,567; 4,994,322; 4,786,696; 4,166,152; 3,857,731; and 3,691,140, the disclosures of which are incorporated here by reference. Other useful adhesives include high peel adhesives that may permanently attach a film sheet. Examples of such adhesives include rubber resin and acrylic adhesives.

Finally, various types of separable surface elements contained in the top portion can be used. Choice can be made based on factors such as cost of production, equipment, and the types of intended applications of the product film. Based on the separable surface elements used, three variations of the method are disclosed herein.

### First Variation of the Method

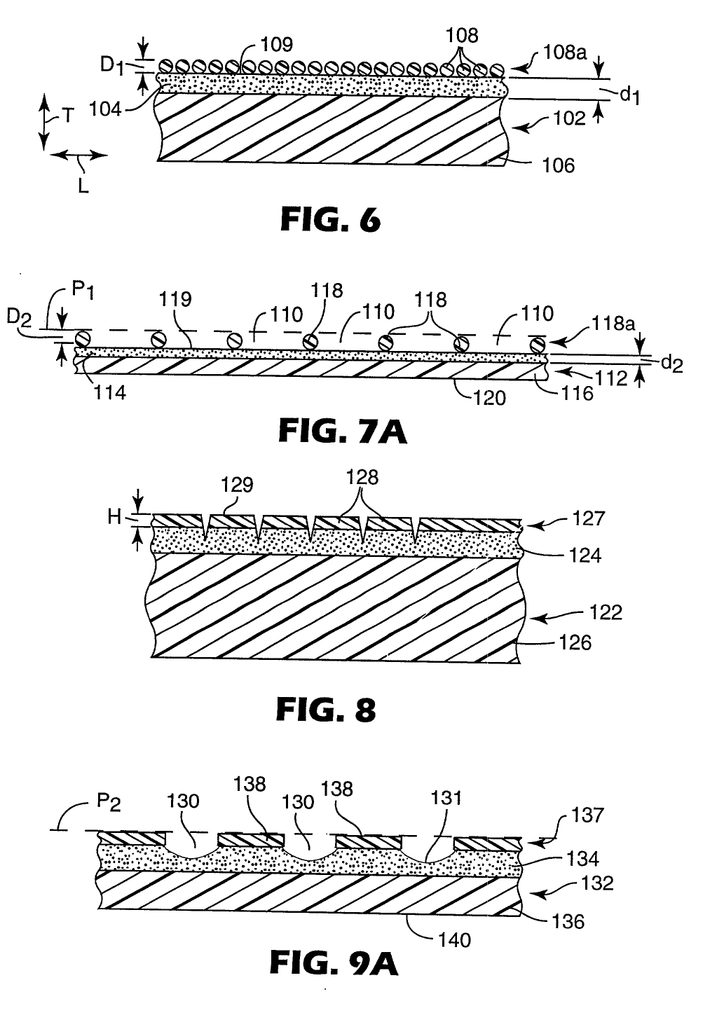

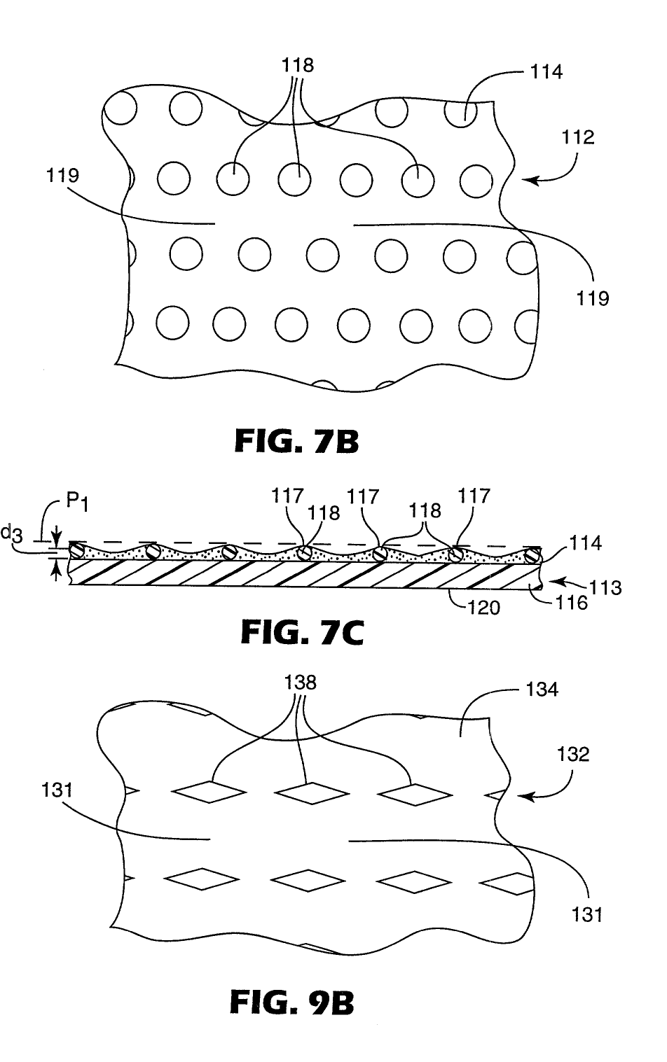

In a first variation of the method, the separable surface elements comprise particles. The first type of embodiment is illustrated with reference to FIGS. 6, 7A, 7B, and 7C.

FIG. 6 shows a side sectional view of a pre-stretching film structure 102 according to an illustrative first variation of the method of the inventive method. The film structure 102 has a first dimension (width, extending perpendicular to the page of FIG. 6), a second dimension (length—as illustrated by L in FIG. 6) and a third dimension (thickness—as illustrated by T in FIG. 6), wherein the first and the second dimensions are preferably much greater than the third dimension. The particular film structure 102 shown in FIG. 6 has an adhesive layer 104 (acting as an operating agent). In one embodiment, the film structure 102 may also have a stretchable base layer 106. A plurality of non-adhesive particles 108 are placed on an exposed surface 109 of the adhesive layer 104 and adhered thereto by the adhesive properties of the adhesive layer 104. For maximum control over the separation of the particles 108 by stretching, particles 108 are preferably, although not required to be, in a closely packed arrangement to each other.

The word “particles” encompasses materials in a powder, fiber or granular form. There are no specific restrictions on the size, or shape of the particles employed, although in general, the size need to be large enough in order to rise above the surface of the operating layer in the finished film. Non-circular particles, fiber-like (elongated) particles, solid or hollow particles, metallic, inorganic, organic, ceramic, organic or polymeric particles may be employed depending on the temperature during processing, and the desired performance in the final film.

In addition, although particles 108 as shown in FIG. 6 are substantially uniform in size (with a diameter D₁), evenly distributed on the surface 109 and form a monolayer 108a, such a selection of particles 108 and distribution thereof is not required. Particles of any shape can be used, as long as they have a required dimension (height) D₁ in the thickness direction T of the film structure 102. Mixtures of populations of particles with differing average size, or populations with a distribution of particle sizes may also be employed to obtain specific performance in the finished film. It is also possible to have multiple applications of various particle populations. For instance, a large-particle population may be applied first to define a monolayer, after which a small-particle population may be applied to fill the interstices of the initial particle layer resulting in a consistent, coordinated arrangement of both populations. Such schemes could be performed multiple times with appropriate sized of particles.

FIGS. 7A and 7B show a sheet material 112 formed from stretching the film structure 102, preferably in both the first and the second dimensions of the film along its width and length (although stretching in just one direction may be sufficient, or stretching in more than two directions may in some instances be desired). The base layer 106 is stretched into a base layer 116. Particles 108 are separated from each other by stretching but remain effective as a monolayer 118a, thereby creating openings or lands 110 between particles 118. The adhesive layer 104 in FIG. 6 is stretched into an adhesive layer 114 in FIG. 7A. A portion of the top surface 119 of the adhesive layer 114 is thus exposed via the openings 110.

A plane P₁ (FIG. 7A) across the top of the monolayer 118a of particles 118 defines a first major surface of the sheet material 112. If particles 118 have different sizes, the first major surface plane P₁ is approximately defined by a plane across the top of some of the largest particles 118. The first major surface P₁ is typically an application side of the sheet material 112, meaning that this side of the sheet material 112 is to be applied to a surface of a target object to obtain an intended effect, such as adhesion.

After stretching, the exposed portions of the adhesive layer 114 have an average thickness d₂(FIG. 7A). Stretching of the film structure (102, 112) may or may not affect the size and shape of the particles 108/118, depending on the properties of the particles 108/118 and the temperature at which the stretching is carried out. Plastic particles, for example, tend to deform during stretching especially at high temperatures. Regardless of whether deformation of particles 108/118 occurs or what the degree of deformation is, in the stretched film structure 112 at least part of the adhesive 114 must remain spaced from the first major surface P₁ of the film structure 112 by an effective distance due to the existence of particles 118. For purpose of illustration, in FIG. 7A, the adhesive 114 remains spaced from the top surface P₁ of the film structure 112 by a distance roughly the same as the diameter (height) D₂ of particles 118, where D₂ is a variable if particles 118 have non-uniform sizes. However, since the particles 118 may sink into the adhesive 114, the above spacing distance is not necessarily the same or close to the diameter (height) D₂ of particles 118.

Although not required, in one embodiment, the height D₂ of at least some of the largest particles 118 is greater than the average thickness d₂ of the exposed portions of the adhesive layer 114 after stretching. This ensures that even if the particles 118 are buried in the adhesive layer 114, the exposed portions of the adhesive 114 remain spaced from the first major surface P₁ of the film structure 112 by an effective distance due to the existence of at least some of the largest particles 118. In still another embodiment, the height D₂ of at least some of the largest particles 118 is at least twice as the average thickness d₂ of the exposed portions of the adhesive layer 114 after stretching. This ensures that even if the particles 118 are buried in the adhesive layer 114, the exposed portions of the adhesive 114 remain spaced from the top surface P₁ of the film structure 112 by a distance equal or greater than the average thickness d₂ of the exposed portions of the adhesive layer 14 due to the existence of at least some of the largest particles 118.

Stretching is preferably inelastic in order to at least partially maintain a certain degree of separation among the separated surface elements (particles 118) after the stretching forces are removed from the film structure 112 and no other external force assisting the separation is present. In this disclosure, inelastic stretching is defined as stretching the film structure, in one or more directions, at least 5% from its initial state (1:1.05), with the final dimension(s) in the stretched film showing a permanent deformation of at least 50% of the imposed stretch (1:1.025). Stretching may be performed at room temperature or the film may be heated to facilitate deformation.

The resultant film structure 112 demonstrates a controllable surface contact property when the first major surface P₁ on the application side (the particle-bearing side) is applied to a surface of a target object. When the operating agent is an adhesive (adhesive layer 114), the film structure 112 demonstrates a tack-on-pressure property. Specifically, the film structure 112 shows a reduced tendency to cling prematurely to itself (and/or to a target surface) because of the existence of particles 118, but shows an increasing degree of adhesion when a proper pressure such as a finger pressure or a hand pressure is applied on a second major surface 120 of film structure 112 in a direction substantially transverse to the target surface. The second major surface 120 is the back of the film structure 112 (e.g., on surface 120 of base layer 116).

In addition to the tack-on-pressure feature, the adhesion performance characteristics of the inventive sheet material may be adjusted based on the spacing between the particles 118, the size of the particles 118, holding power of the adhesive, thickness of the adhesive, and thickness and the stiffness of the base layer (or additional layers and materials which may comprise the base layer).

Particles 108 can be applied to the adhesive surface by flood coating the particles (for instance, using a fluidized-bed coater) prior to the stretching process. Excess particles 108 may be blown off the film web, or shaken off the web to obtain a monolayer of the particles 108 over the adhesive 104 in a consistent fashion. Standard film stretching equipment, such as length-orienters, tenters, etc., may be used to produce the stretched film 112.

Alternatively, the particles 108 can be incorporated in the operating layer 104 (e.g., adhesive 104) by blending the particles 108 into the operating layer 104 and subsequently making a multilayer film 102. In the case of an adhesive layer 104, for example, the particles 108 can be incorporated in the adhesive 104 by blending the particles into the adhesive, and subsequently coextruding or coating the blend on a base material. In this case, particles made of materials with a high melting temperature may be necessary in order to maintain the particle shape through the extrusion process.

The coextruded film can then be stretched to obtain a similar film construction 113 (FIG. 7C) as described above. In the above alternative (FIG. 7C), the operating layer 114 will tend to encapsulate the particles 118, but will generally be thinned out appreciably over the top surfaces 117 of the particles 118 if the effective or average thickness d₃ of the operating layer 114 in the final (stretched) film is smaller that the size of the particles 118. In the case of an adhesive (operating) layer 114, the thinned-out adhesive layer over the particles 118 will result in negligible adhesive holding power, and will result in repositionability of the final film 113. This may afford a more efficient process from a manufacturing viewpoint than having a separate particle coating operation.

The concept of using non-adhesive particles to detackify an adhesive surface is known in the art. U.S. Pat. No. 4,556,595 to Ochi, for example, discloses a pressure sensitive adhesive sheet structure having relocatable properties composed of a pressure sensitive adhesive layer and non-adhesive solid particles randomly but uniformly distributed over the surface of the adhesive layer. The Ochi patent, however, does not teach separating or spacing the particles in a manner as described herein.

The problem of spacing the particles has been addressed by several schemes in the past. These schemes include: 1) spraying/aspirating particles on an adhesive; 2) depositing solids from a liquid medium followed by a drying process; and 3) applying particles indirectly to a patterned liner and then laminating the liner to an adhesive. The prior art processes tend to be expensive, require special equipment and are difficult to manage in the way, which ensures consistency in the end product.

The technique in accordance with the present invention is an improvement over the prior art because the openings between adjacent particles 108 (118 after stretching) are controlled by the degree of stretch imposed on the film 102. By integrating the particle coating process with the process of making the film, high productivity and low costs can be achieved.

For the types of applications envisioned by the present invention, the particles 108/118 do not need to be made of an electrically conductive material. In fact, in certain applications, it may be necessary or desirable that particles 108/118 be made of an electrically non-conductive material. On the other hand, different mechanical properties of particles 108/118 may be desirable for different applications and thus become an important factor that needs to be considered in choosing the material to fabricate particles 108/118.

### Examples of the First Variation of the Method

The present invention is more particularly described in the following examples, which are intended as illustrations only since numerous modifications and variations within the scope of the present invention will be apparent to those skilled in the art.

### Example 1

As an example of the first type embodiment described above, a prototype film structure was made by a process comprising the following steps: (1) Extrusion; (2) Lamination; (3) Flood Coating; and (4) Stretching. Details of the above process are described below.

1. Extrusion

A base polyethylene layer was cast and a 125 mm×125 mm square piece (coupon) was cut from the cast sheet.

The polyethylene used was Mxten CM 27057-F from Eastman Chemicals Co., Kingsport, Tenn. The material is a linear low density polyethylene (LLDPE) resin with a density of 0.910 g/cc (0.910 g/ml) and melt flow index (mfi) of 2. The resin was extruded in a 1.75 inch (44.5 mm) screw HPM extruder (HPM Corp., Mt. Gilead, Ohio) at a melt temperature of 450° F. (232.2° C.). The molten sheet was cast onto a chilled steel roll at 125° F. (51.70° C.). The bottom section of the casting roll was immersed in water to enable heat transfer from the cast sheet. The thickness of the cast sheet was 1250 microns (μm).

2. Lamination

A layer of an adhesive was laminated over the coupon. The hot-melt adhesive used was a commercial blend made by H.B. Fuller Company of St. Paul, Minn. (HL-2697PT). The adhesive was extruded at 400° F. (204.4° C.) using a 0.75 inch (19.05 mm) extruder and was sandwiched between two silicone-coated paper liners. The thickness of the adhesive was 313 microns (μm). A 101 mm×101 mm square of the adhesive (sandwiched between the liners) was cut. After removing one of the liners, the adhesive was transferred to the coupon. The second liner was subsequently removed.

Alternatively, the above extrusion and lamination steps may be replaced by a co-extrusion process in which a two-layer web including the adhesive layer and the base polyethylene layer is coextruded using a conventional extruding method.

3. Flood Coating

Non-adhesive cross-linked polystyrene particles with an average diameter of a 29.6 microns (μm) were manually flood coated on the adhesive side of the laminated coupon. An excess of the above particles was poured on the adhesive surface. The coupon was manually tilted back and forth in order to expose the entire area of the adhesive to the particles. A fixed amount of the particles adhered to the adhesive, essentially producing a monolayer of the particles. The excess amount was removed by holding the coupon upside down and tapping the back of the sheet so that essentially a monolayer of the particles stayed on the adhesive in a consistent self-regulating manner. An average amount of 0.15 gm of the particles adhered to the adhesive. Excess particles (non-adhered particles) may also be blown off or vacuumed off the web in order to obtain a constant loading of the particles on the adhesive.

The particles were prepared by the limited coalescence suspension polymerization method as described in U.S. Pat. No. 5,238,736 (which is hereby incorporated by reference). The specific method used in the present example was as follows: Aqueous mixture of 2139 g deionized water, 15 g Ludox TM-50 colloidal silica (DuPont, Wilmington, Del.), 1.04 g of 50% solution of diethanolamine-adipic acid condensate (as promoter) and 0.48 g of potassium dichromate was stirred and adjusted to pH 4 by addition of 10% sulfuric acid. A monomer solution of 1440 g styrene (Dow Chemical Co., Midland, Mich.), 36 g divinyl benzene-HF (Dow Chemical Co.) and 2.1 g of VAZO 64 initiator (DuPont) was added to the above aqueous mixture, mixed well, and passed through a Manton-Gaulin Homogenizer Model #15 MR (APV Gaulin Corp., Wilmington, Mass.) at about 1000 psi for one minute, and recycled three times. The homogenized suspension was poured into a 5-liter split resin flask equipped with mechanical agitator, condenser and nitrogen inlet. The suspension was then heated to 70° C. under nitrogen and kept for 24 hours to complete polymerization. The polymerized suspension was screened through a 40 mesh sieve, then filtered with #54 filter paper on a Buchner funnel and washed several times with water to give a wet cake containing polystyrene particles of about 30 um. The wet cake was then dried at ambient temperature to give a free-flowing powder.

4. Stretching

The sheet was stretched in a batch stretcher KARO IV Laboratory Stretcher (Bruckner, Siegsdorf, Germany). The stretch temperature was 244.4° F. (118° C.). The coupon was heated for 70 seconds, after which the coupon was stretched at a constant rate of 10% per second to a final stretch ratio of 1:7 in each direction. In the final stretched film, the polyethylene layer was about 22 microns (μm) thick, and the adhesive layer was about 5.5 microns (μm) thick.

Samples from the above sheet prototypes made in accordance with the above process were tested for their adhesion performance. The tests performed are described as follows.

Adhesive-to-Adhesive Test

The non-adhesive side of a 1.5 inch (38.1 mm) wide strip of a sample inventive film was adhered to the test platen of a Slip/Peel Tester (Instrumentors Inc., Strongsville, Ohio) using a 2-sided transfer adhesive. The tester is used to measure the release force for high speed operation.

A 1 inch (25.4 mm) wide strip of the sample film was then laid over the 1.5 inch (38.1 mm) wide strip of sample inventive film (adhesive-side to adhesive-side) and rolled down with either a 200 gm roller or by applying finger pressure.

The samples were then tested in the Slip/Peel Tester to quantify the peel forces (at 90°, and at 12 inches (0.3 m) per minute).

Adhesive-to-Steel Test

A 1 inch (25.4 mm) wide strip of the inventive sample film was laid over a clean stainless steel platen and rolled down with either a 200 gm roller, or by applying finger pressure, and tested with the Slip/Peel Tester.

In addition to the inventive film, a removable office tape (referenced as Clear Scotch® Tape 811, available from Minnesota Mining and Manufacturing Company, St. Paul, Minn.) was also tested for comparison purposes. The methods used to test the comparison film (3M Clear Scotch® Tape 811) were identical to the method used to test the inventive film except that the width of the sample 3M removable office tape used in tests was 0.75 inches (19.05 mm) instead of 1 inch (25.4 mm). Correspondingly, the width of the transfer film used in the adhesive-to-adhesive test for sample removable office tape was also 0.75 inches (19.05 mm) instead of 1 inch (25.4 mm). The test results are given below.

### Peel Force Test Results

1) Particle-coated film (1 inch), average of two specimens (in grams):

TABLE 1

| | adhesive-to-adhesive | | | adhesive-to-steel | | |
|---|---|---|---|---|---|---|
| Roller | Average | High | Low | Average | High | Low |
| 200 gm roller | 9 | 20 | 6 | 2 | 3 | 2 |
| Finger pressure | 210 | 343 | 162 | 26 | 63 | 4 |

2) 3M Clear Scotch® Tape 811 (0.75 inches), average of 3 specimens (in grams):

TABLE 2

| | adhesive-to-adhesive | | | adhesive-to-steel | | |
|---|---|---|---|---|---|---|
| Roller | Average | High | Low | Average | High | Low |
| 200 gm roller | 153 | 164 | 114 | 65 | 81 | 61 |
| Finger pressure | 295 | 343 | 285 | 103 | 114 | 81 |

As shown in the above tables, the sample adhesive film lacks substantial adhesion with light touch, but develops adhesive holding power when a proper amount of pressure is applied to activate the adhesive. Such activatable adhesion or tack-on-pressure property exists in both adhesive-to-adhesive and adhesive-to-nonadhesive contacts. In general, when the film is adhered to itself (adhesive-side to adhesive-side), the peel force is higher than when the film is adhered to other surfaces (such as glass, metal, etc.). The inventive film has many viable applications. For example, the film can be used as a non-tangling food wrap using a finger pressure as activation pressure.

### Example 2

As an example of a film structure having high adhesive-to-adhesive adhesion performance and low adhesive-to-nonadhesive adhesion performance, an alternate example of the particle-coated film structure was made in accordance with the first type embodiment disclosed above. Except as indicated otherwise in the following, the materials used to prepare the alternate example were identical to those in the previous example disclosed above in the first type embodiment.

The thickness of the base sheet was 1500 microns (μm), and that of the adhesive was 625 microns (μm). The crosslinked polystyrene particles had an average diameter of 80 microns (μm). The particle-coated coupon was stretched with a stretch ratio of 1:3.8 in both directions in the KARC, stretcher under conditions identical to the previous example. The resultant film was tested using a test protocol similar to that in the previous example.

Adhesive-to-adhesive: Two 1 inch-wide samples were laminated together with a 4.51b roller, and then peeled apart at 90° (T-peel) with an Instron force tester (commercially available from Instron Corp. Canton, Mass.) at 12″/minute.

Adhesive-to-steel: 1 inch-wide samples were laminated on a stainless steel plate with a 4.51b roller, and then peeled apart at 90° with the Slip/Peel Tester at 12″/minute.

As a comparison, a sample of 3M Scotch® Box Sealing Tape 355 was also tested under the same conditions. The test results are as follows.

### Peel Force Test Results

Particle-coated film compared with 3M Scotch® Box Sealing Tape 355 (in grams):

TABLE 3

| | adhesive-to-adhesive | | | adhesive-to-steel | | |
|---|---|---|---|---|---|---|
| Sample film type | Average | High | Low | Average | High | Low |
| Particle coated film | 2767 | 2948 | 2495 | 5 | 21 | 4 |
| (1:3.8 stretch ratio) | | | | | | |
| 3M Scotch ® Box | 1361 | 1451 | 1270 | 1650 | 1776 | 1590 |
| Sealing Tape 355 | | | | | | |

As shown in Table 3, the alternate particle coated film in accordance with the present invention demonstrated a remarkable difference between its adhesive-to-adhesive peel adhesion and adhesive-to-nonadhesive (steel) peel adhesion. Surprisingly, the particle coated film demonstrated an adhesive-to-adhesive peel adhesion even higher than that of 3M Scotch® Box Sealing Tape 355.

### Second Variation of the Method

In a second variation of the method, the top portion containing separable surface elements comprises a scored or cut masking layer. The second type of embodiment is illustrated with reference to FIGS. 8, 9A and 9B.

FIG. 8 shows a side sectional view of a pre-stretching film structure 122 according to an illustrative second variation of the method of the inventive method. The film structure 122 has a first dimension (width), a second dimension (length) and a third dimension (thickness) wherein the first and the second dimensions are preferably much greater than the third dimension. The particular film structure 122 shown in FIG. 8 has an adhesive layer 124 (acting as an operating agent). In one embodiment, the film structure 122 may also have a stretchable base layer 126. A masking layer 127 is placed on top of the adhesive layer 124 and thus defines a first major surface 129 of the film structure 122. Preferably, the masking layer 127 has a substantially uniform thickness H, evenly spacing the adhesive layer 124 from first major surface 129 of the film structure 122.

As shown in FIG. 8, the masking layer 127 is scored or cut through from the top, preferably in a series of parallel lines (not shown) along the first and the second dimensions, so that the masking layer 127 is scored or cut into a grid of four-sided segments 128 such as squares, diamonds, rectangles or rhombuses, each segment being mechanically isolated from its neighbors. Each segment 128 therefore constitutes a separable surface element. However, there is no requirement for any particular manner of cutting as long as the cutting generates desired separable surface elements 128 on the masking layer 127, although different cutting mechanisms may have different efficiency or productivity. A blade cutter was used in the examples described herein, but any conventional methods such as laser ablation or embossing may be used to sever the masking layer into separable surface elements. Furthermore, there is no requirement for any particular shape or relative sizes of the separable surface elements 128 as long as the final film structure (stretched film) has the desired surface contact properties. In general, each separable surface element 128 resulting from cutting has an n-sided polygon shaped top side.

For the applications envisioned with the present invention, it is desired that separable surface elements 128 have a density, before stretching, of greater than 100 elements per square inch (15.5 elements per square centimeter), preferably 1000 elements per square inch (155 elements per square centimeter), more preferably 2500 elements per square inch (388 elements per square centimeter), before stretching, and still more preferably 10,000 elements per square inch (1550 elements per square centimeter). It is contemplated that a prestretch density of the separable surface elements as high as 40,000 elements per square inch (6200 elements per square centimeter), is possible.

Preferably (as shown in FIG. 8), the masking layer 127 is completely cut through while the adhesive layer 124 is partially cut through, although it may be sufficient to merely weaken or only partially sever the thickness of the masking layer 127 in some manner in order to achieve the desired separation effect. In the embodiment where a stretchable base layer 126 is used, although it is possible that the masking layer 127, either alone or together with the operating agent (adhesive layer) 124, is scored or cut first and then laminated together with the base layer 126, it is preferred that multi layer film structure 112 be formed before cutting of the masking layer 127.

In either of the above situations and unlike that in the first variation of the methods (particles), the separable surface elements 128 are formed directly on a continuous portion of the film structure 122 instead of being incorporated into the film structure as pre-formed discrete pieces as in the case of particles. Here, “a continuous portion of the film structure” refers to one or more of the following depending on the embodiment: the base layer 126, an uncut portion of the adhesive layer 124, or an uncut portion of the masking layer 127.

FIGS. 9A and 9B show a sheet material 132 formed from stretching the film structure 122, preferably in both the first and the second dimensions of the film (again, stretching in just one direction, or more than two directions, may be desired in some instances). Base layer 136 in FIG. 9A is a result of stretching the base layer 126 in FIG. 8. Adhesive layer 134 is a result of stretching the adhesive layer 124 in FIG. 8. Segments 138 of the masking layer (127, 137) also stretch out and become separated from each other by the stretching, thereby creating openings, recesses or lands 130 between segments 138 yet still serving to some degree as a masking layer 137 for the adhesive layer 134. The openings (recesses or lands) 130 facilitate at least a partial exposure of portions of intermediate surface 131, which is a portion of upper surface of the adhesive layer 134 as shown, but may be just a face of recess 130 when no operating agent is used. As opposed to the particles 108 of the first variation of the method, stretching may reduce the thickness of the surface segments.

A plane P₂ (FIG. 9A) across the top of the masking layer 137 defines a first major surface of the film structure 132. The exposed intermediate surface portions 131 of the adhesive layer 134 are spaced from the plane P₂ by the segments 138 with a distance at least the same as the thickness of the segments 138, which may or may not remain the same as the thickness H of original segments 128. The first major surface is typically an application side of the film structure 132, meaning that this surface or side of the film structure 132 is to be applied to a surface of a target object to obtain an intended effect, such as adhesion.

The resultant sheet material 132 has a controllable surface contact property such as adhesion performance similar to that of the sheet material 112 illustrated in the first variation of the method. The sheet material 132 has islands of non-adhesive protrusions (segments 138) that protect an operating agent (adhesive layer 134) from premature contact with a target surface. The operating agent can then be contacted against the target surface by application of a finger or hand pressure on the backside 140 of the sheet material 132.

Examples of the Second Variation of the Method

As an example of the second variation of the method described above, a prototype sheet material was made by a process comprising the following steps: (1) Co-extruding a film web; (2) Cutting; and (3) Stretching. Details of the above process are described below.

1. Co-extrusion

A three-layer film including a top polyethylene (PE) masking layer, an adhesive layer, and a polyethylene (PE) base layer was coextruded using a three-layer feedblock attached to a 7 inch (18 cm) slot die. The pre-stretch thickness of the top masking layer, the adhesive layer and the base layer was 1.5 mil (0.038 mm), 10 mils (0.254 mm), and 25 mils (0.635 mm), respectively.

The top and base PE resin was Mxten CM 27057-F LLDPE from Eastman Chemicals Co., Kingsport, Tenn. The adhesive blend was a 75%-25% blend (by weight) of Kraton D 1107 from Kraton Polymers, Houston, Tex. and HL-2697 PT from H.B. Fuller Company. These are commercial materials used in hot-melt pressure sensitive adhesive (PSA) formulations. Kraton D 1107 is a styrene-isoprene-styrene block copolymer. HL-2697 PT is based on a tackified block-copolymer composition.

The top PE layer was extruded using a 0.75 inch (19.05 mm) Killion extruder with screw speed at 33 RPM and gate temperature at 470° F. (243.3° C.). The adhesive layer was extruded using a 1.25 inch (31.75 mm) Brabender extruder (C. W. Brabender, Hackensack, N.J.) with screw speed at 34 RPM and gate temperature at 400° F. (204.0° C.). The base PE was extruded using a 1.75 inch (44.45 mm) HPM extruder with screw speed at 35 RPM and gate temperature at 470° F. (243.3° C.). The feedblock and die were operated at 470° F. (243.3° C.).

The casting wheel temperature was controlled at 125° F. (51.7° C.) with the base PE contacting the wheel. The film web was pinned with air, and the surface speed of the wheel was 1.7 m/min.

2. Cutting

The web was cut in a direction generally perpendicular to the surface of the web. The web was on a supported surface such that it was cut through a constant thickness of the web. The depth of cut was controlled by moving the support relative to the position of the cutter. A set of parallel cuts at 22.5° angle to the machine direction of the web were made. The produced cuts were parallel to each other and approximately 10 mils (0.254 mm) apart.

The web was then turned 45° and again fed through the cutter in order to create another set of parallel cuts at a 45° angle relative to the original cut direction.

In both cutting directions, the depth of cut was adjusted so that the cut was completely through the top PE layer, and approximately 50% of the way through the thickness of the adhesive layer. This was monitored using a microscope.

The resulting pattern consisted of physically isolated diamonds of the top PE layer adhered to a continuous layer of adhesive.

3. Stretching

3 inch×3 inch (7.6 cm×7.6 cm) samples were cut out of the above cut-web and stretched in a batch stretcher. Each sample was stretched to a stretch ratio of 1:5.5 simultaneously in both directions at a rate of 0.25 inch (6.35 mm) per second at 115° C. The resulting film had a surface feature defined by separated diamond-shaped islands. These islands space the adhesive layer from the first major surface of the film. An approximate thickness profile of the resulting film is given as follows.

TABLE 4

| | At diamonds | | | Between diamonds | |
|---|---|---|---|---|---|
| | top layer | adhesive layer | base layer | adhesive layer | base layer |
| Thickness (in | 1.0 | 1.2 | 1.2 | 0.3 | 1.1 |
| mils, 1 mil = | | | | | |
| 0.0254 mm) | | | | | |

The base PE layer was stretched relatively uniformly, while the stretched adhesive layer showed some topographical variation depending on its proximity to the diamond-shaped islands (segments 138 in FIG. 9A). This feature results in the tack-on-pressure characteristic.

The above description pertains to a specific example that uses the inventive film forming method. Variations of the method will be clear to one skilled in the art. For example, cutting may be performed using a variety of schemes. Instead of using a cutter as described above, alternate cutting or surface weakening schemes such as a water-jet, laser-beam, rotary-die, or embossing roll may be used. In general, water-jets and laser-beams may result in a wider cut swath than a cutter. Further, water-jets and laser-beams are best suited when the cutting direction is along the machine direction. One advantage with a laser beam is that intricate patterns such as waves, squiggles, predefined contours, etc. can be accomplished by programming the path into the laser scanning device. It is also envisioned that in certain situations (e.g., by using a brittle top layer), cutting can be effectively performed using an embossing roll.

The size and geometry of the islands, such as diamonds, squares, rectangles, or any general parallelograms, can be varied based on cutting at various angles and at various cutting spacings. The spacing can be controlled by the relative speed of the web, and the speed of the cutting device. With the materials in the above example, the minimum distance along the machine direction that resulted in good separation of the diamonds was about 250 microns (μm). When the cuts were made closer there was an increased risk of the top PE layer delaminating from the adhesive, and subsequently not separating into islands but instead forming clusters of diamonds due to this delamination. By using alternate materials, such as using a top layer material that has a higher bond strength to the adhesive layer, closer cuts would be possible.

It is also possible to have cuts only in one direction, whereby a ribbed pattern can be formed in the final film. Tandem cutting is possible where multiple cuts are made along parallel directions using multiple cutting stations in order to obtain smaller cut spacing than would be possible with just a single cut in that direction. Multiple cuttings at multiple angles would result in other shapes such as triangles and other polygons. It is, therefore, possible to achieve a wide variety of controllable shapes and sizes of the topographical features or the separable surface elements.

Samples were tested under conditions identical to that for the peel force test of the samples in the first type embodiment (Table 1)

Cut film (1 inch, 25.4 mm), average of two specimens (in grams):

TABLE 5

| | adhesive-to-adhesive | | | adhesive-to-steel | | |
|---|---|---|---|---|---|---|
| Roller | Average | High | Low | Average | High | Low |
| 200 gm roller | 26 | 52 | 9 | 23 | 34 | 13 |
| Finger pressure | 114 | 150 | 66 | 62 | 73 | 54 |

As shown in Table 5, the sample film demonstrated a tack-on-pressure property similar to that of the first variation of the method.

### Third Variation of the Method

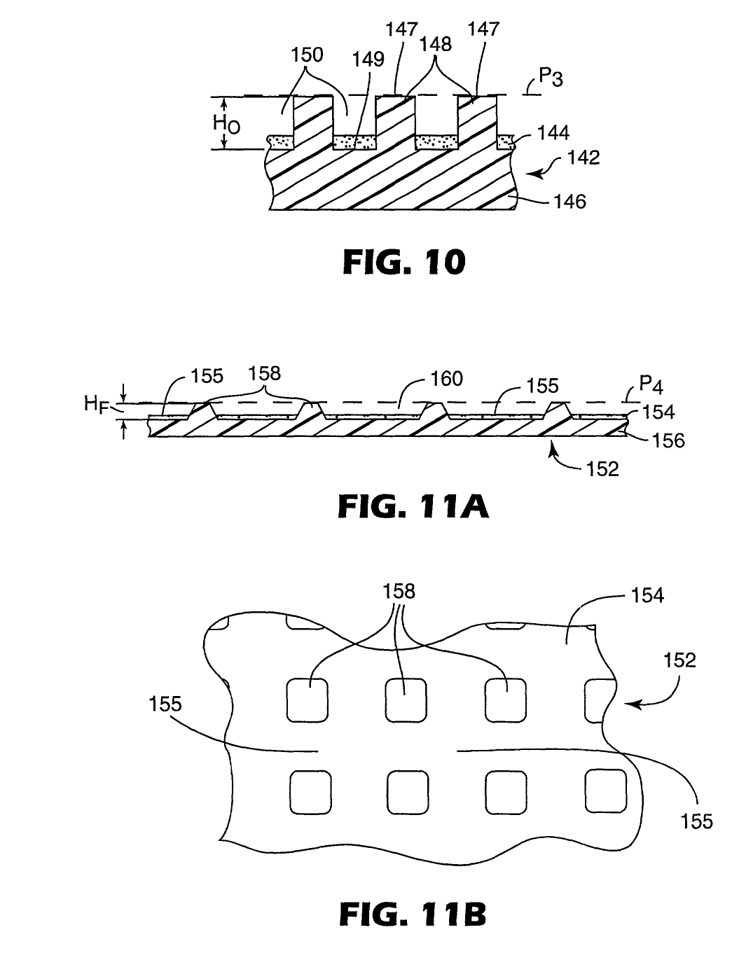

In a third variation of the method, the top portion containing separable surface elements comprises stems of a stemmed-web film. The third type of embodiment is illustrated herein with reference to FIGS. 10, 11A and 11B.

FIG. 10 shows a side sectional view of a pre-stretching stemmed-web film structure 142 according to an illustrative third variation of the method of the inventive method. The film structure 142 has a first dimension (width), a second dimension (length) and a third dimension (thickness) wherein the first and the second dimensions are preferably much greater than the third dimension.

The film structure 142 has a stretchable base layer 146 from which a plurality of stems 148 extend. Although the stems 148 can be separately formed, they are preferably formed as an integral part of the base layer 146. For example, a stemmed web film structure 142 with stems 148 extending from a base layer 146 and above an adhesive layer 144 can be cast by coextruding the adhesive and the base layer simultaneously using a microstructured tool. A method used to extrude the stemmed web film structure 142 is described in detail in U.S. Pat. No. 6,106,922, co-owned by the assignee of the present application. The above patent application is hereby incorporated by reference herein. It is preferred that the top ends 147 of the stems 148 be essentially devoid of adhesive 144. To this end, the material rheology and other process conditions are closely controlled in order to have the base layer 146 puncture through the adhesive layer 144 during the process forming stems 148. In general, low viscosity base layer resins resulted in better puncturing-through of the stems through adhesive layer 144, with the stem tips 147 being essentially devoid of the adhesive 144. It was found that a material having a melt flow index (mfi) greater than 50 is preferred when used as a base layer 146.

The stems 148 are preferably separate from each other and leave openings, recesses or lands 150 between them. The stems can have any desired shape, such as cylindrical, tapered, conical, square in section, etc. An operating agent 144 is disposed on intermediate surface 149 (non-stemmed top surface of the base layer 146 as shown) at opening 150. The particular film structure 142 shown in FIG. 10 has an adhesive layer 144 (acting as an operating agent). The adhesive of the adhesive layer 144 at one opening 150 may be separate from the adhesive at another opening 150, but preferably all of the adhesive is deposited over the surface 149 of the base layer 146 as a connected layer (the stems 148 are thus like islands among the adhesive layer 144).

A first major surface of the film structure 142 is defined by the tops of the stems 148, as illustrated by plane P₃ in FIG. 10. Preferably, the stems 148 have a substantially uniform height H_{O} which is greater than the thickness of the adhesive 144, thereby evenly spacing the adhesive layer 144 from the first surface of the film structure 142.

FIGS. 11A and 11B show a film structure 152 formed from inelastic stretching the film structure 142, preferably in both the first and the second dimensions of the film. Stems 158 in FIG. 11A are the result of stretching the stems 148 in FIG. 10. As a result of the stretching, the stems 158 are shorter and further apart from each other, thereby creating larger openings, recesses or lands 160 between them. Although not required, adhesive layer 144 in FIG. 10 is preferably stretched along with the base layer 146 (which becomes base layer 156 in FIG. 11A after stretching). Adhesive layer 154 in FIG. 11A is the result of stretching the adhesive layer 144 in FIG. 10. The openings (recesses or lands) 160 facilitate at least a partial exposure of portions of intermediate surface 155, which is a portion of upper surface of the adhesive layer 154 as shown, but may be just a face of recess 160 when no operating agent is used. The first major surface of the film structure 152 is still defined by the tops of the stems 158, as illustrated by plane P₄ in FIG. 11A. Furthermore, the height of the stems 158 is reduced from H_{O} to H_{F} by stretching. Preferably, H_{F} is still greater than the thickness of the adhesive layer 154, thereby spacing the adhesive layer 154 from the first major surface of the film structure 152.

The plane across the top of the stems 158 (plane P₄) defines a first major surface of the film structure 152. The first major surface is typically an application side of the film structure 152, meaning that this surface or side of the film structure 152 is to be applied to a surface of a target object to obtain an intended effect, such as adhesion.

The resultant film structure 152 has controllable surface contact property such as adhesion performance similar to that of the film structures 112 and 132 illustrated in the first type of embodiments and the second type of embodiments, respectively. The film structure 152 has islands of non-adhesive protrusions (stems 158) that protect an operating agent (adhesive layer 154) from premature contact with a target surface. The operating agent can thus be selectively contacted against the target surface by application of a proper pressure such as a finger or hand pressure.

Examples of the Third Variation of the Method

As an example of the third variation of the method described above, a prototype sheet material was made by a process comprising the following steps: (1) Co-extruding a film web; and (2) Stretching. Details of the above process are described below.

1. Co-extrusion

A stemmed web with stems extending from a base layer and above an adhesive layer was cast by coextruding the adhesive and the base layer simultaneously using a microstructured tool with 900 holes per square inch (140 holes/cm²), wherein each hole corresponds to a stem 148 in a molding process. The base layer was a PE-rubber copolymer SRD7587 made by Union Carbide, a subsidiary of the Dow Chemical Company, Midland Mich. The adhesive layer was made from HL-2697 PT (a tackified block copolymer) made by H.B. Fuller Company, St. Paul, Minn.

2. Stretching

Stretching was performed biaxially in the batch stretcher with a stretch ratio of 1:3.5 in each direction at 298° F. (148° C.). The strain rate was 12.5% per second based on a 2.75 inch (70 mm) gauge-length. After stretching, the height of the stems was reduced from an original height (H₀ ) of approximately 12 mil ( 0.3 mm) to a final height (H_{f}) of about 4.2 mil ( 0.11 mm). At the same time, the opening between the stems was widened from 20 mil (0.5 mm) to about 100 mil (2.5 mm) (as measured between adjacent stems). The approximate geometries of the pre-stretching stemmed-web and the stretched web are summarized as follows.

TABLE 6

| | | Top-to-top | Base | Adhesive |
|---|---|---|---|---|
| | Stem height | Spacing | thickness | thickness |
| Stemmed-web (in mils, | 12 | 20 | 8 | 4 |
| 1 mil = 0.0254 mm) | | | | |
| Stretched web (in mils) | 4.2 | 100 | 0.8 | 0.2 |

The experiment illustrates that with an optimum combination of material properties and process conditions, a wide variety of finished geometries can be achieved, resulting in various film performance characteristics.

### SUMMARY OF THE METHOD OF MAKING

The extent of stretching dictates separation of the separable surface elements. For each choice of base and adhesive materials and stretch conditions such as temperature and stretch rate or stretch ratio, there is an optimum range of stretch ratio. The preferred ranges of stretch ratios to integrate the process within a conventional film line varies, among other factors, with the material used for the base layer (106, 116, 126, 136, 146 and 156). Wider separations result in increased separations of the non-adhesive protrusions (separable surface elements). An optimum stretch ratio may be chosen based on the desired performance and the height of the protrusions.

Although a symmetric biaxial stretching is preferred for this application, various performance characteristics may be obtained by other stretching schemes, including uniaxial, asymmetric biaxial, sequential biaxial, simultaneous biaxial stretching, etc.

Depending on the spacing (size of opening) between the separable surface elements (such as particles, scored segments and stems), the size of the separable surface elements, the thickness and adhesion performance of the adhesive, and the stiffness and thickness of the film base, various other adhesion performances can be obtained. For instance, a film with negligible adhesion to flat surfaces, but with significant adhesion to itself (adhesive-face to adhesive-face) can be obtained using the method described herein. Such a film may be considered to be an inexpensive adhesive analog to a mechanical fastener.

Additionally, although the above described process is best suited for a cast stretch film process, blown film processes may also be employed.

Furthermore, variations of the multi-layer web described in the above examples can offer additional performance characteristics. For instance, a third or fourth layer with an anti-block additive can be included to reduce the inherent cling in the base PE layer. For applications in accordance with the present invention, the top layer could be a pigmented layer, such as TiO₂, which could potentially offer cosmetic and indicative properties.

Although the present invention has been described with reference to preferred embodiments, all described above are presented for illustration purposes only. Workers skilled in the art will recognize that changes may be made in form and detail without departing from the spirit and scope of the invention.

1. A method for temporary surface protection or surface modification, comprising:
providing a sheet material having an activatable adhering side and an opposing utility side, wherein:
the sheet material has a base portion having physical characteristics of having been non-elastically stretched in at least one dimension by a stretch ratio of at least 1:1.05;
the activatable adhering side comprises a plurality of predetermined surface elements separated from each other leaving openings between adjacent surface elements, separation being caused by stretching of the sheet material; and
the sheet material further has an adhesive layer at least partially exposed to the activatable adhering side through the openings between surface elements such that after activation by a user, the activatable adhering side exhibits an adhesion peel force greater than an adhesion peel force exhibited prior to activation by a user;
applying the activatable adhering side of the sheet material on a target surface; and
activating the activatable adhering side.

2. The method of claim 1, wherein the activatable adhering side is activated by applying a finger or hand pressure.

3. The method of claim 1, wherein the sheet material is adapted to be easily repositionable after being applied to the target surface and easily removable after being activated.

4. The method of claim 1, wherein at least a portion of the sheet material is impermeable to fluids through the utility side.

5. The method of claim 1, wherein at least a portion of the sheet material is absorbent to fluids.

6. The method of claim 1, wherein the sheet material is highly flexible such that it can be easily conformed to the target surface.

7. The method of claim 1, wherein the utility side of the sheet material has a higher coefficient of friction than the target surface when contacted by an object such as a tool or human skin.

8. The method of claim 1, wherein the utility side of the sheet material has an optical characteristic different from that of the target surface.

9. The method of claim 1, wherein the sheet material is provided in a roll form.

10. The method of claim 1, wherein the sheet material is provided in pre-cut discrete sheets.

11. The method of claim 1, wherein the utility side of the sheet material is aseptic for providing infection protection.

12. The method of claim 1, wherein the utility side of the sheet material bears an antibacterial agent.

13. The method of claim 1, wherein the sheet material is transparent to visible light.

14. The method of claim 1, wherein the sheet material is translucent to visible light.

15. The method of claim 1, wherein the sheet material is at least partially impermeable to light of wavelengths in a specific range.

16. The method of claim 1, wherein the sheet material is at least partially opaque to visible light.

17. The method of claim 1, wherein the sheet material is adapted to provide radiation protection.

18. The method of claim 1, wherein the utility side bears printed indicia.

19. A method for temporary surface protection or surface modification in a hospital or dental office, the method comprising:
providing a multilayer sheet material having an activatable adhering side and an opposing utility side, wherein after activation by a user, the activatable adhering side exhibits an adhesion peel force greater than an adhesion peel force exhibited prior to activation by a user, such that the sheet material is easily repositionable before being activated and still removable by peeling after being activated;
applying the activatable adhering side of the sheet material on a target surface commonly found in a hospital or a dental office, wherein the utility side of the sheet material provides a desired surface contact property not available on the target surface;
activating the activatable adhering side; and
removing the sheet material from the target surface after the desired surface contact property is no longer required.

20. The method of claim 19, wherein the activating step comprises:
activating a desired potion or portions of the activatable adhering side only.

21. The method of claim 19, wherein the target surface defines a first target surface, the method further comprising:
after removing the sheet material from the first target surface, applying the activatable adhering side of the sheet material on a second target surface commonly found in a hospital or a dental office.

22. The method of claim 19, wherein the target surface is a smooth surface.

23. The method of claim 19, wherein the target surface is on a patient's body and the sheet material is adapted to be used as a medical drape.

24. The method of claim 19, wherein the desired surface contact property is impermeability to fluids through the utility side.

25. The method of claim 19, wherein the desired surface contact property is a high absorbency to fluids.

26. The method of claim 19, wherein the desired surface contact property is a high coefficient of friction when contacted by an object.

27. The method of claim 19, wherein the desired surface contact property is a color.

28. The method of claim 19, wherein the desired surface contact property is partial or total radiation impermeability.

29. The method of claim 19, wherein the sheet material is at least partially transparent to visible light.

30. The method of claim 19, wherein the sheet material is at least partially translucent to visible light.

31. The method of claim 19, wherein the sheet material is at least partially impermeable to light having a wavelength suitable to cause polymerization of a light activated dental material.

32. The method of claim 19, wherein the sheet material is opaque to visible light.

33. The method of claim 19, wherein the utility side bears printed indicia.

34. A bib wearable by a user, comprising:
an activatable adhering side, wherein after activation by a user, the activatable adhering side exhibits an adhesion peel force greater than an adhesion peel force exhibited prior to activation by a user, such that the bib does not dislodge itself from the user after being activated on the user but is easily removable by peeling even after being activated; and
an opposing utility side, through which side the bib is impermeable to fluids.

35. The bib of claim 34 adapted for use by a patient in a hospital or a dental office.

36. The bib of claim 35, wherein at least a part of the utility side is a material absorbent to fluids such that a dental practitioner can dispose waste or wipe dental instruments thereon.

37. The bib of claim 35, wherein the utility side bears printed indicia.
